(19) United States
(12) Patent Application Publication
(10) Pub. No.: US 2024/0422399 A1
(43) Pub. Date: Dec. 19, 2024

(54) LIVESTREAM WITH LARGE LANGUAGE MODEL ASSIST

(71) Applicant: Loop Now Technologies, Inc., San Mateo, CA (US)

(72) Inventors: Edwin Chiu, Cupertino, CA (US); Shi Feng, East Palo Alto, CA (US); Jerry Ting Kwan Luk, Menlo Park, CA (US); Michael A Shoss, Milton (CA)

(73) Assignee: Loop Now Technologies, Inc., San Mateo, CA (US)

(21) Appl. No.: 18/820,456

(22) Filed: Aug. 30, 2024

Related U.S. Application Data
(63) Continuation-in-part of application No. 18/585,212, filed on Feb. 23, 2024.
(60) Provisional application No. 63/649,966, filed on May 21, 2024.
(60) Provisional application No. 63/638,476, filed on Apr. 25, 2024.
(60) Provisional application No. 63/571,732, filed on Mar. 29, 2024.
(60) Provisional application No. 63/557,622, filed on Feb. 26, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.

(51) Int. Cl. H04N 21/4788; H04N 21/2187; H04N 21/254; H04N 21/472

(52) U.S. Cl. CPC H04N 21/4788; H04N 21/2187; H04N 21/2542; H04N 21/47217

(57) ABSTRACT

A computer-implemented method for video analysis is disclosed. A livestream, including a livestream chat, is accessed. The livestream includes products for sale. The livestream includes timestamps based on when each product is highlighted. The timestamps allow users to jump to livestream locations based on the highlighted products. The livestream is monitored by a large language model. The large language model (LLM) detects a question from users in the livestream, and the LLM determines answers to the question. An engagement metric is calculated for each answer. The engagement metric is predictive of future engagement in the livestream by users if the answer is posted. A human assistant in the livestream reviews the LLM answer with the highest engagement score and chooses to edit the answer, to post the answer, or not to post the answer to the livestream.

### RELATED APPLICATIONS

This application claims the benefit of U.S. provisional patent applications “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

This application is also a continuation-in-part of U.S. patent application “Synthesized Realistic Metahuman Short-Form Video” Ser. No. 18/585,212, filed Feb. 23, 2024, which claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video analysis and more particularly to a livestream with large language model assist.

### BACKGROUND

Asking questions is one of the most basic and important components of communication. We ask questions to learn about the world around us, in matters big and small. Many young children begin with the question “Why?” Many parents have been reminded that answering that question only once can be a challenge. As children grow older, the list of questions expands to the common fact gathering list of who, what, when, where, and why. From news articles to book reports, scientific research papers to philosophical treatises, these basic questions form the heart of countless works of fact, fiction, and art as well. While the language may differ, the quest for knowledge, discovery, and the endeavor to put possible answers on display drives many an artist to render their questions and answers in paint, sound, color, texture, stone, wood, metal, drama, poetry, and prose.

Science and industry grow and thrive on questions. Questions about how the natural world works have led to thousands of discoveries which have motivated the management of our natural resources differently over time. Figuring out how plants and animals process food, water, and air has led to breakthroughs in medicine and nutrition. Understanding how insects communicate has inspired the development of short-range networks and encoded messaging. Working out how the human brain functions has influenced the development of artificial intelligence, neural networks, blockchain data storage, and other technical breakthroughs based on biological systems. These advances have all come from asking one question after another and using the answers to generate even more questions to be explored.

The world of commerce makes daily use of questions as well. Asking customers about how a particular product impresses them can lead to changes in design, color, texture, marketing strategies, and so on. Surveying focus groups can generate new products or help a company decide that an established product is no longer viable. Giving out samples in grocery stores and listening to shoppers' feedback can help vendors understand shifts in consumer preferences. Salespeople and shopkeepers know that talking with their customers, finding out what they prefer, listening to how they use what they buy, or understanding what they would like to see next can all make the difference between staying in business or being left behind. Large internet-based companies collect millions of pieces of information on consumers every day, and marketers and developers in every field ask these consumer databases all sorts of questions to determine which consumer group likes what product, what color of cars are most popular, how high can the price of milk go before people start buying alternatives, what size of computer screen is purchased most often, how many umbrellas will be sold after it rains for an hour, and on and on. The questioning goes both ways. Customers themselves can ask as many questions as the manufacturers and vendors do. Many vendor websites include one or more FAQ (Frequently Asked Questions) sections as a way of trying to quickly answer questions that come from their customers again and again. Help desk staff members spend much of their time answering customer questions about how to use a product, how to fix a product, how to update a product, and so on. As long as our desire to understand and grow remains, questions will continue to be asked and answered.

### SUMMARY

Livestream events have become an important channel for promoting and selling goods and services. Like any successful methodology, the number of livestream events, replays, and short-form video commercials based on livestream extracts has grown exponentially. The number of viewers participating in the events has grown as well. It is now commonplace for text, audio, and even video chats to run in real time as the livestream events are rendered to viewers. This allows for immediate feedback from the viewers as various products and services are highlighted. Ecommerce windows included in the livestream promote immediate sales, adding to the engagement of the viewers and hosts. The chat window also attracts a plethora of comments and questions, often so many that the livestream hosts can have difficulty in responding to all of them. Some questions are answered by other viewers, but not always accurately. In many cases, the livestream hosts and operators are privy to information regarding various products that the livestream viewers do not know. Responding to viewer questions in an accurate manner that keeps the viewers engaged and motivated to purchase products is therefore an important part of managing a successful livestream.

A computer-implemented method for video analysis is disclosed. A livestream, including a livestream chat, is accessed. The livestream includes products for sale. The livestream includes timestamps based on when each product is highlighted. The timestamps allow users to jump to livestream locations based on the highlighted products. The livestream is monitored by a large language model. The large language model (LLM) detects a question from users in the livestream, and the LLM determines answers to the question. An engagement metric is calculated for each answer. The engagement metric is predictive of future engagement in the livestream by users if the answer is posted. A human assistant in the livestream reviews the LLM answer with the highest engagement score and chooses to edit the answer, to post the answer, or not to post the answer to the livestream.

A computer-implemented method for video analysis is disclosed comprising: accessing a livestream, wherein the livestream includes a livestream chat and one or more products for sale from a catalog of products, and wherein the livestream includes at least one host and a plurality of users; monitoring, by a large language model (LLM), the livestream chat, wherein the monitoring detects a question from a user within the plurality of users; determining, by the LLM, an answer to the question that was detected; calculating an engagement metric, for the answer, wherein the engagement metric is predictive of a future engagement in the livestream, by one or more users within the plurality of users, if the answer was posted in the livestream chat; and posting, in the livestream chat, the answer to the question, if the engagement metric is above a threshold value. In embodiments, the determining comprises a plurality of potential answers to the question that was detected. In embodiments, calculating includes the plurality of potential answers that were determined. Some embodiments comprise choosing, by the LLM, from the plurality of potential answers that were determined, the potential answer with the highest engagement metric.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a livestream with large language model assist.

FIG. 2 is a flow diagram for enabling a livestream with large language model assist.

FIG. 3 is an infographic for a livestream with large language model assist.

FIG. 4 is an infographic for editing a large language model answer in a livestream.

FIG. 5 is an infographic for rewinding a livestream.

FIG. 6 is an example of training a large language model in a livestream.

FIG. 7 is an example of an ecommerce purchase environment.

FIG. 8 is a system diagram for a livestream with large language model assist.

### DETAILED DESCRIPTION

Livestreams that highlight products and services for sale are immensely popular and can attract hundreds if not thousands of users watching the presentations in real time. Text, audio, and video chats are normally an integral part of the livestream events, inviting questions and comments one after another. Along with the technical challenges involved in supporting and maintaining solid network connections with livestream users across the country, or sometimes across the globe, the challenge of responding to viewer questions and comments quickly and accurately can be equally difficult. Getting to the right information quickly and sending it back to the user or users looking for it can be the difference between a sale or a potential customer leaving the livestream altogether. Understanding the subtleties of user questions can be a challenge. Some users just like asking questions and interacting with others, whether or not they are truly interested in purchasing anything. Other users can have hidden agendas, such as discouraging the use of particular products, boycotting certain manufacturers or retailers, or promoting alternate products sold elsewhere. Identifying these users and handling them effectively can make the role of livestream host or assistant even more challenging. Large language models (LLMs) as part of an artificial intelligence neural network can help the livestream host or assistant by monitoring the chats in real time and generating answers to questions as they arise. The answers can be scored by the LLM for their level of engagement—how likely they are to keep users engaged with the livestream and thus how likely they are to purchase products or services. The LLM can also be effective at identifying users who should be answered privately in order to address rabbit trails or alternative reasons for participating in the livestream. As the volume of chat communication increases, the uses of LLM in livestream chats can help encourage viewer engagement, increase sales, and maintain the focus of the livestreams.

Techniques for video analysis are disclosed. A livestream with at least one livestream host, a group of users, and a catalog of products for sale can be accessed. The livestream can include an ecommerce environment, allowing the users to purchase products and services while the livestream progresses. In embodiments, timestamps are ingested by a time-series model to create LLM embeddings for associating speech context, host audio transcript, and/or product highlights dynamically. Each timestamp can be associated with a product symbol and/or title and can be displayed to the user, allowing the user to rewind the livestream and view products of interest to them. The livestream can include a chat that can use text, audio, and/or video to allow communication between the livestream hosts, users, livestream assistants, operators, and an artificial intelligence (AI) large language model. The livestream assistant can support the host and augment the work of a large language model (LLM) as it interacts with the host and the livestream users. The LLM can monitor the chat and detect questions that are posted by the users as products are presented and highlighted by the livestream hosts. The LLM can generate multiple answers to the questions and score them for the level of overall engagement for all viewers they are likely to produce if posted to the livestream chat. The engagement metric can be based on many factors such as the number of products viewed or purchased by the user, the number of views of short-form videos, multiple views of the same short-form video, sections of the livestream rewatched, number of likes, length of engagement, and so on. The engagement metric can use metadata that can include hashtags, purchase history, repost velocity, view attributes, view history, ranking, actions by one or more viewers, predicted user personality, predicted livestream sentiment impact, and so on. The answers and related engagement metrics can be displayed to the livestream assistant, along with one or more recommendations from the LLM, as to which answer to post, whether to post an answer at all, whether to post an answer privately or publicly, and so on. The livestream assistant can choose to post an answer to the public chat, post it privately to the user who asked the question, combine answers, change the wording of an answer, and so on. The answer can be broad or detailed. The answer can include links to additional information, short-form videos, purchase details, and so on. In some cases, the livestream assistant can choose to use a shadow posting method to display the selected answer to the user while making it appear as a normal post to the entire livestream group. This can be done to address problems that can arise from users who ask many questions, tend to distract the livestream group, or take the discussion off topic. It can also help to address users who want to convince other livestream users not to purchase certain kinds of products or boycott certain brands, etc. The overall impact of the LLM in assisting the livestream host and assistant is to generate answers to user questions that enhance the engagement of the group to the livestream, leading to better sales and long-term satisfaction with the livestream provider.

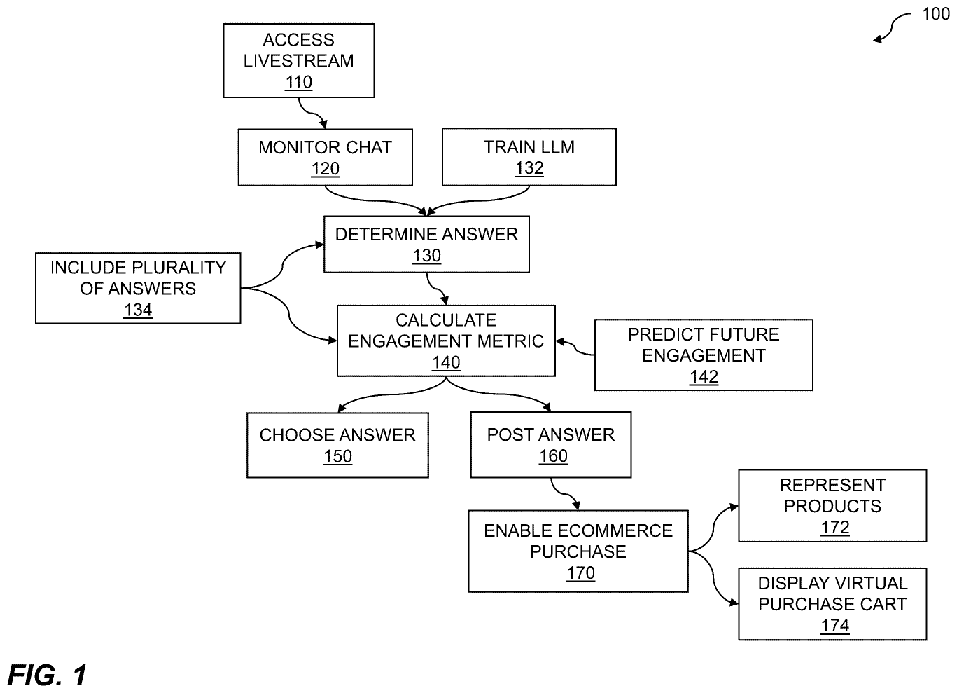

FIG. 1 is a flow diagram for a livestream with large language model assist. The flow 100 includes accessing a livestream 110, wherein the livestream includes a livestream chat and one or more products for sale from a catalog of products, and wherein the livestream includes at least one host and a plurality of users. A livestream is a streaming media event simultaneously recorded and broadcast over the Internet in real time or near real time. A livestream chat allows livestream viewers to interact with the livestream host and other viewers of the livestream using text or voice. In embodiments, the chat text can appear in a window included in the livestream video. In some embodiments, voice interactions can be displayed as text in the chat window as they occur. A large language model can monitor the text chat window and voice chat messages and respond using the same chat methods. In embodiments, the livestream comprises a livestream replay. The livestream can comprise a short-form video. The livestream can be hosted by an ecommerce website, a social media network site, etc. The accessing includes all images, videos, audio, text, chats, media, and products for sale contained in the livestream. The livestream can include a human assistant. The human assistant can be a visible host of the livestream or can work off-camera as the livestream is rendered to viewers. The human assistant can participate in the livestream chat using voice or text. In embodiments, the livestream can be displayed on a portable device. The portable device can include a mobile phone, laptop computer, tablet, or pad, an Over-the-Top (OTT) device, and so on. The accessing the livestream can be accomplished using a browser or another application running on the device. The catalog of products can include information regarding multiple products. The information can include images, product specifications, pricing, availability, links to ecommerce sites associated with products, and/or other suitable information. In some embodiments, the catalog can be used as training data for the large language model.

The flow 100 includes monitoring 120, by a large language model (LLM), the livestream chat, wherein the monitoring detects a question from a user within the plurality of users. In embodiments, the monitoring can include voice input from the user. A large language model is a type of machine learning model that can perform a variety of natural language tasks, including generating and classifying text, answering questions in a human conversational manner, and translating text from one language to another. The LLM monitoring can include audio and text interactions between viewers, the livestream host, and the human livestream assistant. The viewer interactions can include questions, responses, and comments that occur during the livestream event. The monitoring by the LLM can include natural language processing (NLP). NLP is a category of artificial intelligence (AI) concerned with interactions between humans and computers using natural human language. NLP can be used to develop algorithms and models that allow computers to understand, interpret, generate, and manipulate human language. NLP includes speech recognition; text and speech processing; encoding; text classification, including text qualities, emotions, humor, and sarcasm, and classifying it accordingly; language generation; and language interaction, including dialogue systems, voice assistants, and chatbots. In embodiments, the livestream audio monitoring includes NLP to understand the text and the context of voice and text communication during the livestream. NLP can be used to detect one or more topics discussed by the livestream host and viewers. Evaluating a context of the livestream can include determining a topic of discussion during the livestream; understanding references to and information from other livestreams; learning about products for sale or product brands; and becoming acquainted with livestream hosts associated with a brand, product for sale, or topic. The LLM natural language processing can be used to detect questions asked by livestream viewers.

The flow 100 includes determining 130, by the LLM, an answer to the question that was detected. In embodiments, the determining can include a plurality of potential answers 134 to the question that was detected. The LLM can search for one or more answers to the question that was detected from its database and render the answers in human-like language. For instance, a user may ask, “How much does this product cost?” The LLM can detect the question and search the product catalog for pricing information. The LLM can then generate an answer such as “The product costs 100 dollars per dozen.” The LLM can generate additional answers including “Here are the purchase options available for this product”, followed by a product card that displays the various purchase options, colors, sizes, shipping information, and so on. A user may ask a question like, “Is this product suitable for sensitive skin?” The LLM can generate answers based on information from the vendor website, from dermatology websites, from comments made by other users of the product, from health care experts, from social media influencers, and so on. In embodiments, the answers include a compliment to the user to foster further engagement.

The flow 100 can include training 132 the LLM. In embodiments, the training can include the catalog of the one or more products for sale. The training can include host information or company information. The training can include a context of the livestream or a transcript of the livestream. The training can include one or more previous livestreams. The training can include one or more previous comments or a chat history. In embodiments, the training of the large language model can be accomplished using a genetic algorithm. A genetic algorithm is an adaptive heuristic search algorithm that can be used to generate high-quality sets of options for solving optimization questions, such as finding the best answers to a question generated by a user regarding a product for sale. In embodiments, a heuristic algorithm is used to generate solutions that are good enough to move forward in a reasonable frame of time. They comprise best guesses based on the available data that can be created quickly and used to create the next iteration of parameters for a generative AI model. The generative AI model can be trained with all the available information from the first iteration of short-form video generation, including the catalog of products for sale; information on the host website, details about the company selling the products in the product catalog, vendor information, or previous livestreams related to particular products for sale; transcripts of previous livestreams, chat history; viewer comments; and so on. All of these inputs can be used to gather factual information about products, opinions expressed by users and vendors, alternate uses of products discovered by users or social media influencers, and so on. The language used by various sources can also be analyzed by the LLM, so that questions generated by users can more easily be understood, and the answers generated by the LLM more closely match the language used by the viewers asking questions.

The flow 100 includes calculating an engagement metric 140 for the answer, wherein the engagement metric is predictive of a future engagement 142 in the livestream, by one or more users within the plurality of users, if the answer was posted in the livestream chat. The engagement metric can include sales goals, the number of products viewed, and/or the number of products purchased. The engagement metric can also include views of short-form videos, multiple views of the same short-form video, sections of the livestream rewatched, number of likes, number of comments, length of engagement, and so on. The engagement metric can use website and viewer metadata. The metadata can include hashtags, purchase history, repost velocity, view attributes, view history, ranking, actions by one or more viewers, predicted user personality, predicted livestream sentiment impact, and so on. As the livestream progresses, multiple calculations of the engagement metric can be taken and compared. The engagement metric can also be saved to the metadata of highlighted products for sale for future reference and refinement as multiple users view the same livestream segment at different times. The engagement metric can use stochastic analysis techniques to determine a score indicating the user level of interest and interaction with the livestream as it progresses. In embodiments, the calculating can include the plurality of potential answers to the user questions that are detected. An engagement metric can also be calculated as a predicted score based on the various answers generated by the LLM. For example, a user can ask, “Which golf ball do professionals prefer?” One answer generated by the LLM might be “Most of the professional golfers in the US use the SuperWhite 7 golf ball in tournaments.” Another answer might be, “John Brown, the player with the highest winnings so far this season, endorses the DotMaster golf ball.” All answers generated by the LLM can be sorted by their predicted engagement score so that the best scoring answers appear first. In some embodiments, a threshold value can be established so that answers with engagement scores that fall below the threshold can be removed from the list and replaced by others. The calculating can include highlighting, to the human assistant, the answer, wherein the engagement metric is close to the threshold value. The calculating can further include recommending, by the LLM, an action to the human assistant. The flow 100 includes choosing 150, by the LLM, from the plurality of potential answers that were determined, the potential answer with a highest engagement metric.

The flow 100 includes posting 160, in the livestream chat, the answer to the question, if the engagement metric is above a threshold value. In embodiments, the posting can include approving, by the human assistant, the answer to the question. In some embodiments, the human assistant can display all of the answers generated by the LLM to each user question, ranked by their associated engagement metric. The answers that fall below the established threshold value can be marked using color, an icon, italics, and so on. The posting can further include editing, by the human assistant, the answer that was determined by the LLM. The human assistant can open a text box that includes a selected answer generated by the LLM and edit it. The human assistant can combine two or more answers to give a more complete perspective, to reorder information within the answer, or to change the wording to better fit the language of the user. The posting can further include publishing, by the human assistant, the answer that was edited instead of the original answer generated by the LLM. The posting can include a weblink to purchase the one or more products. The human assistant can choose to post the answer to all viewers of the livestream or post it as a private communication to the user asking the question. In some embodiments, the posting can include a shadow post, wherein the shadow post restricts viewing of the answer to the user, and wherein the shadow posts appear as a normal post to the user. The LLM or the human assistant may determine that a particular user tends to distract other viewers by asking one question after another or asking unrelated questions. Metadata, interactions from previous livestreams, data from other vendors or social media sites, etc. can be used to indicate user tendencies and patterns that lower engagement metric scores. For example, a user may ask questions or make comments that are intended to criticize or dissuade viewers from purchasing particular products or services from certain vendors. There may be additional reasons for the LLM or the human assistant to reply to a user using a shadow post so that the user receives an answer but does not distract the rest of the viewers or detract from the overall engagement of the livestream.

The flow 100 includes enabling 170, within the livestream, an ecommerce purchase of the one or more products for sale. In embodiments, the enabling can include representing the one or more products for sale in an on-screen product card. The ecommerce purchase can include a virtual purchase cart. The ecommerce purchase can include displaying 174, within the livestream, the virtual purchase cart. In embodiments, the virtual purchase cart can cover a portion of the livestream. The livestream host can demonstrate, endorse, recommend, and otherwise interact with one or more products for sale. An ecommerce purchase of at least one product for sale can be enabled to the viewer, wherein the ecommerce purchase is accomplished within the video window. As the host interacts with and presents the products for sale, a product card representing one or more products 172 for sale can be included within a video shopping window. An ecommerce environment associated with the video can be generated on the viewer's mobile device or other connected television device as the rendering of the video progresses. The ecommerce environment on the viewer's mobile device can display a livestream or other video event and the ecommerce environment at the same time. A mobile device user can interact with the product card in order to learn more about the product with which the product card is associated. While the user is interacting with the product card, the livestream video continues to play. Purchase details of the at least one product for sale can be revealed, wherein the revealing is rendered to the viewer. The viewer can purchase the product through the ecommerce environment, including a virtual purchase cart. The viewer can purchase the product without having to “leave” the livestream event or video. Leaving the livestream event or video can include having to disconnect from the event, open an ecommerce window separate from the livestream event, and so on. The video can continue to play while the viewer is engaged with the ecommerce purchase. In embodiments, the video or livestream event can continue “behind” the ecommerce purchase window, where the virtual purchase window can obscure or partially obscure the livestream event. In some embodiments, the synthesized video segment can display the virtual product cart while the synthesized video segment plays. The virtual product cart can cover a portion of the synthesized video segment while it plays.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow, or portions thereof, 100 can be included on a semiconductor chip and implemented in special purpose logic, programmable logic, and so on.

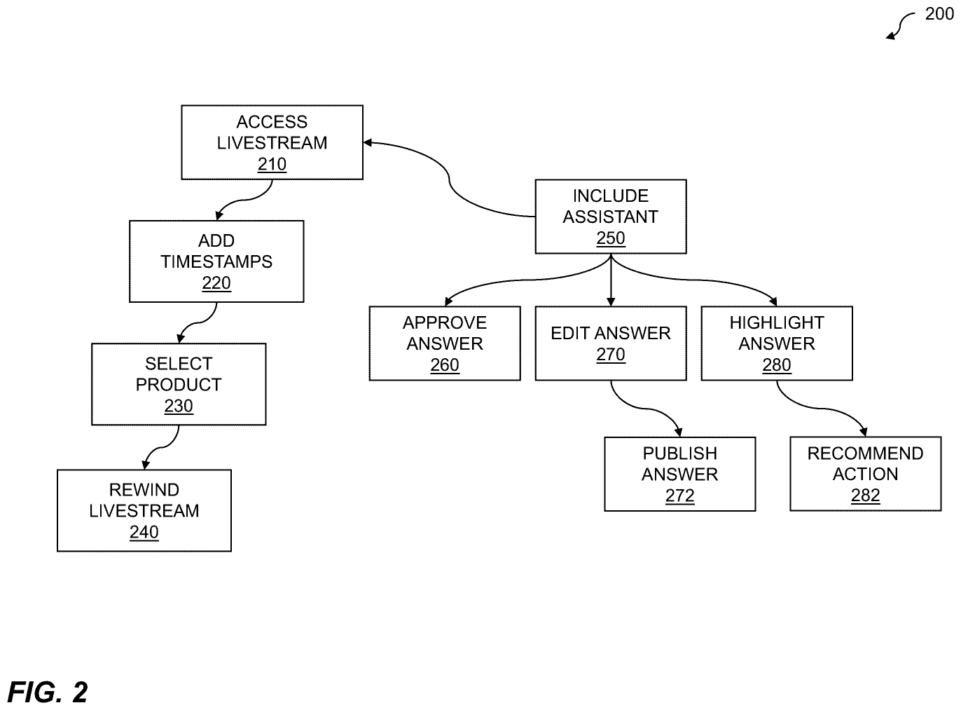

FIG. 2 is a flow diagram for enabling a livestream with large language model assist. A livestream that includes a livestream chat and products for sale from catalog of products can be accessed. The livestream can include at least one livestream host, a plurality of users, and a human livestream assistant. The livestream assistant can be the livestream host or a separate individual working on or off-camera. In some embodiments, the livestream assistant can be an AI neural network model. The livestream assistant can approve, edit, or highlight an answer that was generated by the LLM. In embodiments, the livestream assistant can write a different answer. In embodiments, these actions aim to increase engagement in the livestream. To make products more accessible to the plurality of users, timestamps can be added to the livestream. The timestamps allow a user within the plurality of users to select a product, thereby rewinding the livestream to a point where that product was described by the host. The rewinding can increase user engagement in the livestream, allowing easier access to product information.

The flow 200 includes accessing a livestream 210, wherein the livestream includes a livestream chat and one or more products for sale from a catalog of products, and wherein the livestream includes at least one host and a plurality of users. As described above and throughout, a livestream is a streaming media event simultaneously recorded and broadcast over the Internet in real time or near real time. A livestream chat allows livestream viewers to interact with the livestream host and other viewers of the livestream using text or voice. In embodiments, the chat text can appear in a window included in the livestream video. In some embodiments, voice interactions can be displayed as text in the chat window as they occur. A large language model (LLM) can monitor the text chat window and voice chat messages, and can respond using the same chat methods.

The flow 200 includes adding 220 one or more timestamps to the livestream, wherein each timestamp in the one or more timestamps represents a location in the livestream relevant to a product within the one or more products for sale. In embodiments, the adding can be accomplished dynamically by machine learning. The livestream can include a listing of the one or more products for sale. As the livestream plays, products highlighted by the livestream host can be selected by the LLM and matched to products for sale in the product catalog. In some embodiments, an image can be selected from the product catalog or another location to represent each product. A timestamp marking the beginning and the end of each discussion highlighting a product can be recorded by the LLM and associated with the image. In some embodiments, additional timestamps can be associated with the product image. The additional timestamps can be associated with a short-form video or 3D image of the product being highlighted; product specifications including color, dimensions, capacities, and pricing; and so on. In embodiments, the products highlighted in the livestream can be rendered to the livestream viewers in a list displaying each highlighted product, a title for the product, a button that allows the user to select 230 the product, and so on. The timestamps can include selecting 230, by the user, a first product within the one or more products for sale that were listed. The timestamps can further include rewinding the livestream 240 to the timestamp relevant to the first product that was selected, wherein the timestamp relevant to the product that was selected occurs earlier than a current point in the livestream. The rewinding can include the main livestream video highlighting the selected product and the associated chat interactions that occurred during the original presentation of the product. The user can pause or rewind the livestream again, ask additional questions, explore links included in the LLM responses to see additional information about the product, purchase a product using an ecommerce environment included in the livestream (discussed below), and so on. Additional questions and responses from the LLM or human assistant can be added to the recorded livestream so that the next user that rewinds the livestream or views it later can see the additional questions and responses as part of the livestream segment associated with the selected product.

The flow 200 can include monitoring, by a large language model (LLM), the livestream chat, wherein the monitoring detects a question from a user within the plurality of users. In embodiments, the monitoring can include voice input from the user. The LLM monitoring can include audio and text viewer interactions between viewers, the livestream host, and the human livestream assistant. The viewer interactions can include questions, responses, and comments that occur during the livestream event. The monitoring by the LLM can include natural language processing (NLP). NLP can be used to develop algorithms and models that allow computers to understand, interpret, generate, and manipulate human language. NLP includes speech recognition; text and speech processing; encoding; text classification, including text qualities, emotions, humor, and sarcasm, and classifying it accordingly; language generation; and language interaction, including dialogue systems, voice assistants, and chatbots. In embodiments, the livestream audio monitoring includes NLP to understand the text and the context of voice and text communication during the livestream. NLP can be used to detect one or more topics discussed by the livestream host and viewers. Evaluating a context of the livestream can include determining a topic of discussion during the livestream; understanding references to and information from other livestreams; learning about products for sale or product brands; and becoming acquainted with livestream hosts associated with a brand, product for sale, or topic. The LLM natural language processing can be used to detect questions asked by livestream viewers.

The flow 200 can include determining, by the LLM, an answer to the question that was detected. In embodiments, the determining can include a plurality of potential answers to the question that was detected. The LLM can search for one or more answers to the question that was detected from its database and render the answers in human-like language. For instance, a user may ask, “How much does this product cost?” The LLM can detect the question and search the product catalog for pricing information. The LLM can then generate an answer such as “The product costs 100 dollars per dozen.” The LLM can generate additional answers including “Here are the purchase options available for this product”, followed by a product card that displays the various purchase options, colors, sizes, shipping information, and so on. A user may ask a question like, “Is this product suitable for sensitive skin?” The LLM can generate answers based on information from the vendor website, from dermatology websites, from comments made by other users of the product, from health care experts, from social media influencers, and so on.

The flow 200 can include calculating an engagement metric, for the answer, wherein the engagement metric is predictive of a future engagement in the livestream, by one or more users within the plurality of users if the answer was posted in the livestream chat. The engagement metric can use sales goals, the number of products viewed, and the number of products purchased. The engagement metric can further include views of short-form videos, multiple views of the same short-form video, sections of the livestream rewatched, number of likes, length of engagement, and so on. The engagement metric can use website and viewer metadata. As the livestream progresses, multiple calculations of the engagement metric can be taken and compared. The engagement metric can be related to the metadata of highlighted products for sale for future reference and can be refined as multiple users view the same livestream segment at different times. The engagement metric can use stochastic analysis techniques to determine a score indicating the user level of interest and interaction with the livestream as it progresses. In embodiments, the calculating can include the plurality of potential answers to the user questions that are detected. An engagement metric can also be calculated as a predicted score based on the various answers generated by the LLM. In some embodiments, a threshold value can be established so that answers with engagement scores that fall below the threshold can be removed from the list and replaced by others.

The flow 200 can continue with the livestream including a human assistant 250. In embodiments, the human assistant 250 can be the livestream host or a separate individual working on or off-camera. In some embodiments, the livestream assistant can be an AI neural network model. The human assistant can aid the process of increasing engagement by monitoring and taking actions based on LLM responses. In embodiments, the human assistant decides whether to post, to the livestream, a response by the LLM when a generated response is close to the threshold engagement value. In other embodiments, the human assistant chooses from a list of responses generated by the LLM.

The flow 200 can include approving 260, by the human assistant, the answer to the question. As described above and throughout, the LLM can generate one or more answers to a question posed by a user in the livestream. In embodiments, the human assistant can approve the answer generated by the LLM before it is posted into the livestream. In other embodiments, the human assistant approves the answer, but causes the post to be rendered in a shadow format, wherein the shadow post restricts viewing of the answer to the user, and wherein the shadow post appears as a normal post to the user.

The flow 200 can include editing 270, by the human assistant, the answer that was determined by the LLM. The human assistant can open a text box that includes a selected answer generated by the LLM and edit it. The human assistant can combine two or more answers to give a more complete perspective, reorder information within the answer, or change the wording to better fit the language of the user. The posting can further include publishing 272, by the human assistant, the answer that was edited. In embodiments, the publishing includes a weblink to purchase the one or more products. The human assistant can choose to publish the answer to all viewers of the livestream or to post it as a private communication to the user asking the question. In some embodiments, the publishing includes a shadow post, wherein the shadow post restricts viewing of the answer to the user, and wherein the shadow post appears as a normal post to the user.

The flow 200 can includes highlighting, to the human assistant, the answer 280, wherein the engagement metric is close to the threshold value. In some embodiments, the highlighting includes displaying, to the human assistant, all the answers generated by the LLM to each user question, ranked by their associated engagement metric. The answers that fall below or just below the established threshold value can be marked using color, an icon, italics, and so on. The human assistant can then approve those answers that they believe will best increase user engagement on the livestream. In other embodiments, the highlighting includes indicating, by the LLM, from the plurality of potential answers that were determined, the potential answer with the highest engagement metric. Further embodiments include recommending, by the LLM, an action 282 to the human assistant. In embodiments, the recommended action includes a LLM posting privately to a user or using a shadow post in response to a user's question or comment. The LLM or the human assistant may determine that a particular user tends to distract other viewers by asking one question after another or asking unrelated questions. Metadata, interactions from previous livestreams, data from other vendors or social media sites, etc. can be used to indicate user tendencies and patterns that lower engagement metric scores. For example, a user may ask questions or make comments that are intended to criticize or dissuade viewers from purchasing particular products or services from certain vendors. Thus, the LLM can recommend that such a user's question be ignored. In embodiments, the LLM recommends publishing a link to purchase an item that the user inquired about. In other embodiments, the LLM recommends that a second user answers the question posed by a first user to generate additional engagement. The second user can be selected based on past comment history, purchase history, metadata, and so on.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

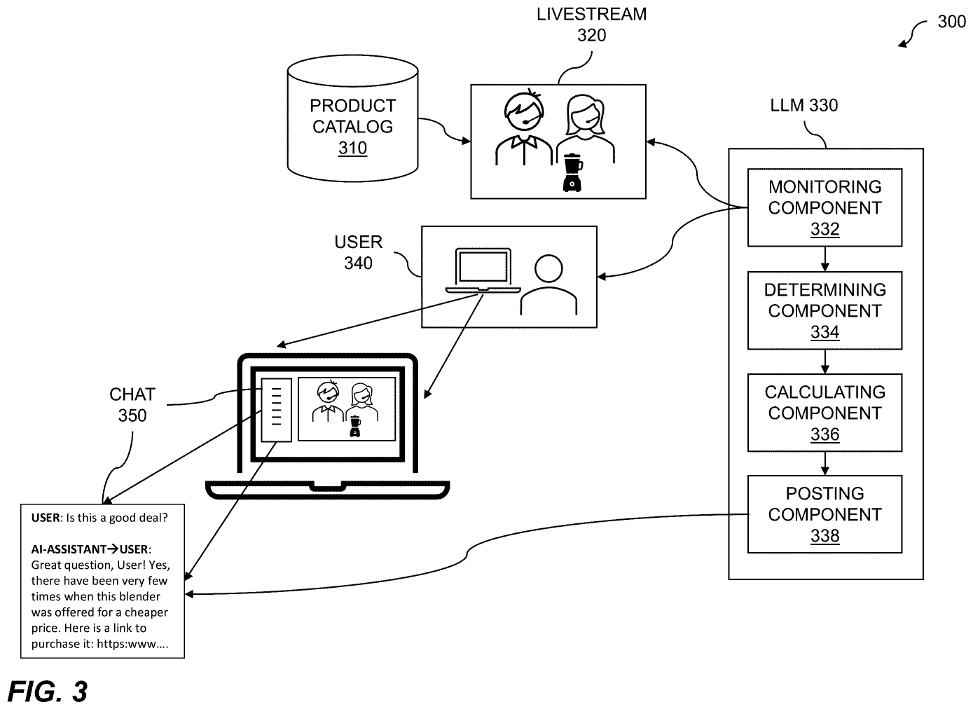

FIG. 3 is an infographic for a livestream with large language model assist. A livestream with at least one host, a group of users, and a catalog of products for sale can be accessed. The livestream can include a chat that can use text, verbal exchanges, and/or video to allow the host to communicate with users, to allow users to communicate with one another, and to enable communication with an artificial intelligence (AI) large language model. A human or AI livestream assistant can support the host and augment the work of the large language model (LLM) as it interacts with the host and the livestream users. The LLM can monitor the chat communications as they occur and detect questions that are posed by the users as various products are presented and highlighted by the livestream hosts. The LLM can generate multiple answers to the user questions and score them for the level of overall engagement for all viewers they are likely to produce if posted to the livestream chat. The engagement metric can be based on multiple elements such as sales goals, the number of products viewed or purchased by the user, the number of views of short-form videos, multiple views of the same short-form video, sections of the livestream rewatched, number of likes, length of engagement, and so on. The engagement metric can use website and viewer metadata. The metadata can include hashtags, purchase history, repost velocity, view attributes, view history, ranking, actions by one or more viewers, predicted user personality, predicted livestream sentiment impact, and so on. The various answers and accompanying engagement metrics can be displayed to the livestream assistant, along with one or more recommendations from the LLM, as to which answer to post, whether or not to post an answer at all, whether to post an answer privately or publicly, and so on. The livestream assistant can choose to post an answer to the public chat, post it privately to the user who asked the question, combine answers, change the wording of an answer, and so on. The answer can be highly detailed or general. The answer can include links to additional information, short-form videos, purchase details, and so on. In some cases, the livestream assistant can choose to use a shadow posting method to display the selected answer to the user while making it appear as a normal post to the entire livestream group. This can be done to address problems that can arise from users who ask many questions, one after another, and tend to distract the livestream group or take the discussion off topic. It can also help to address users who want to convince other livestream users not to purchase certain kinds of products or to boycott certain brands, etc. The overall impact of the LLM in assisting the livestream host and assistant is to generate answers to user questions that enhance the engagement of the group to the livestream, leading to better sales and long-term satisfaction with the livestream provider.

The infographic 300 can include accessing a livestream 320, wherein the livestream includes a livestream chat 350 and one or more products for sale from a catalog of products 310, and wherein the livestream includes at least one host and a plurality of users 340. A livestream 320 is a streaming media event simultaneously recorded and broadcast over the Internet in real time or near real time. A livestream chat 350 allows livestream users 340 to interact with the livestream host and other viewers of the livestream in real time using text or voice. In embodiments, the chat text 350 can appear in a window included in the livestream video. In some embodiments, voice interactions can be displayed as text in the chat window as they occur. In some embodiments, the chat can include video from the livestream users. A large language model (LLM) 330 can monitor the text chat window and voice chat messages and respond using the same chat methods. In embodiments, the livestream 320 can comprise a livestream replay. The livestream can comprise a short-form video. The livestream can be hosted by an ecommerce website, a social media network site, etc. The accessing includes all images, videos, audio, text, chats, media, and products for sale contained in the livestream. The livestream can include a human assistant. The human assistant can be a visible host of the livestream or can work off-camera as the livestream is rendered to viewers. The human assistant can participate in the livestream chat using voice or text. The accessing the livestream can be accomplished using a browser or another application running on the device. The catalog of products 310 can include information regarding multiple products. The information can include images, product specifications, pricing, availability, links to ecommerce sites associated with products, and/or other suitable information.

The infographic 300 can include a monitoring component 332, used by a large language model (LLM) to monitor the livestream chat, wherein the monitoring detects a question from a user within the plurality of users. In embodiments, the monitoring can include voice input from the user. The LLM monitoring 332 can include audio, text, and/or video viewer interactions among viewers, the livestream host, and the human livestream assistant. The viewer interactions can include questions, responses, and comments that occur during the livestream event. The monitoring by the LLM can include natural language processing (NLP). NLP is a category of artificial intelligence (AI) concerned with interactions between humans and computers using natural human language. In embodiments, the livestream monitoring includes NLP to understand the text and the context of voice and text communication during the livestream. NLP can be used to detect one or more topics discussed by the livestream host or viewers. Evaluating a context of the livestream can include determining a topic of discussion during the livestream; understanding references to and information from other livestreams; learning about products for sale or product brands; and becoming acquainted with livestream hosts associated with a brand, product for sale, or topic. The LLM natural language processing can be used to detect questions asked by livestream viewers.

The infographic 300 can include a determining component 334, used by the LLM 330, to determine an answer to the question that was detected. In embodiments, the determining component 334 can include a plurality of potential answers to the question that was detected. The LLM 330 can search for one or more answers to the question that was detected from its database and render the answers in human-like language. For instance, a user may ask, “How much does this product cost?” The LLM can detect the question and search the product catalog for pricing information. The LLM can then generate an answer such as “The product costs 100 dollars per dozen.” The LLM can generate additional answers including “Here are the purchase options available for this product”, followed by a product card that displays the various purchase options, colors, sizes, shipping information, and so on. A user may ask a question like, “Is this product suitable for sensitive skin?” The LLM can generate answers based on information from the vendor website, from dermatology websites, from comments made by other users of the product, from health care experts, from social media influencers, and so on.

The infographic 300 can include a calculating component 336 as part of the LLM 330. The calculating component 336 can be used to generate an engagement metric for the answer, wherein the engagement metric is predictive of a future engagement in the livestream, by one or more users within the plurality of users, if the answer was posted in the livestream chat. The engagement metric can use sales goals, the number of products viewed, and the number of products purchased. The engagement metric can be further based on views of short-form videos, multiple views of the same short-form video, sections of the livestream rewatched, number of likes, length of engagement, and so on. The engagement metric can use website and viewer metadata. The metadata can include hashtags, purchase history, repost velocity, view attributes, view history, ranking, actions by one or more viewers, predicted user personality, predicted livestream sentiment impact, and so on. As the livestream progresses, multiple calculations of the engagement metric can be taken and compared. The engagement metric can also be recorded to the metadata of highlighted products for sale for future reference and refinement as multiple users view the same livestream segment at different times. The engagement metric can use stochastic analysis techniques to determine a score indicating the user level of interest and interaction with the livestream as it progresses. In embodiments, the calculating can include the plurality of potential answers to the user questions that are detected. An engagement metric can also be calculated as a predicted score based on the various answers generated by the LLM. For example, a user can ask, “Which golf ball do professionals prefer?” One answer generated by the LLM might be, “Most of the professional golfers in the US use the SuperWhite 7 golf ball in tournament.” Another answer might be, “John Brown, the player with the highest winnings so far this season, endorses the DotMaster golf ball.” All answers generated by the LLM can be sorted by their predicted engagement score so that the best scoring answers appear first. In some embodiments, a threshold value can be established so that answers with engagement scores that fall below the threshold can be removed from the list and replaced by others. The calculating can include highlighting, to the human assistant, the answer, wherein the engagement metric is close to the threshold value. The calculating can further include recommending, by the LLM, an action to the human assistant. The infographic 300 includes choosing, by the LLM, from the plurality of potential answers that were determined, the potential answer with a highest engagement metric.

The infographic 300 can include a posting component 338 within the LLM 330. The posting component 338 can post, in the livestream chat, the answer to the question, wherein the engagement metric is above a threshold value. In embodiments, the posting can include approving, by a human assistant, the answer to the question. In some embodiments, the human assistant can display all of the answers generated by the LLM to each user question, ranked by their associated engagement metric. The answers that fall below the established threshold value can be marked using color, an icon, italics, and so on. The posting can further include editing, by the human assistant, the answer that was determined by the LLM. The human assistant can open a text box that includes a selected answer generated by the LLM and edit it. The human assistant can combine two or more answers to give a more complete perspective, reorder information within the answer, or change the wording to better fit the language of the user. The posting can further include publishing, by the human assistant, the answer that was edited instead of the original answer generated by the LLM. The posting can include a weblink to purchase the one or more products. The human assistant can choose to post the answer to all viewers of the livestream, or post it as a private communication to the user asking the question. In some embodiments, the posting can include a shadow post, wherein the shadow post restricts viewing of the answer to the user, and wherein the shadow post appears as a normal post to the user. The LLM or the human assistant may determine that a particular user tends to distract other viewers by asking one question after another or asking unrelated questions. Metadata, interactions from previous livestreams, data from other vendors or social media sites, etc., can be used to indicate user tendencies and patterns that lower engagement metric scores. For example, a user may ask questions or make comments that are intended to criticize or dissuade viewers from purchasing particular products or services from certain vendors. There may be additional reasons for the LLM or the human assistant to reply to a user using a shadow post so that the user receives an answer but does not distract the rest of the viewers or detract from the overall engagement of the livestream.

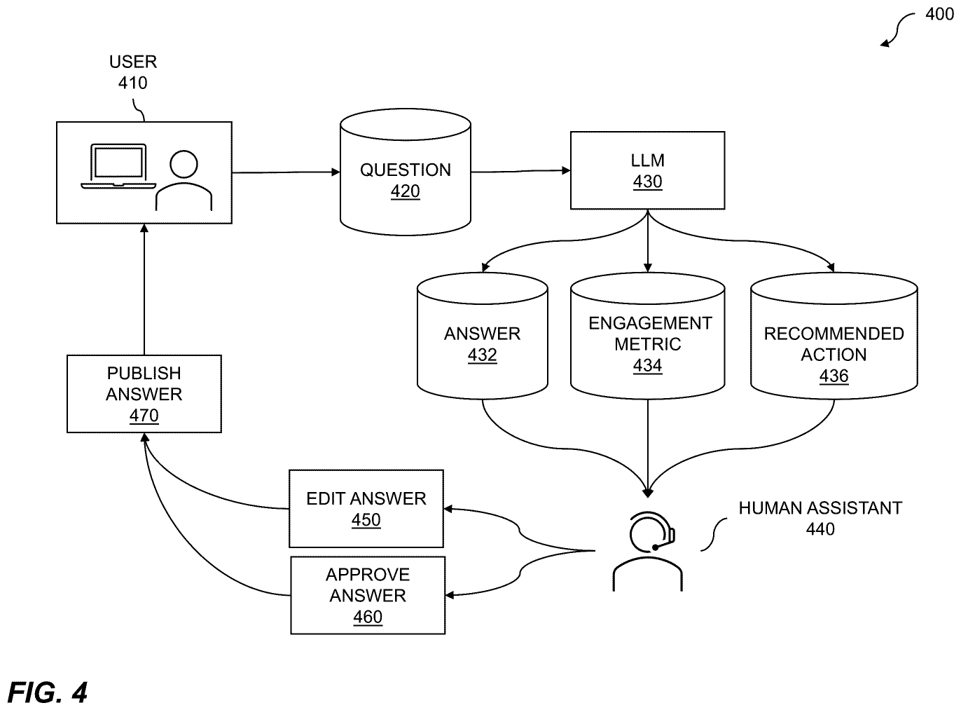

FIG. 4 is an infographic for editing a large language model answer in a livestream. The infographic 400 can include a user 410 accessing a livestream which includes a livestream chat, one or more products for sale, a livestream host, and a human livestream assistant 440. In some embodiments, the livestream assistant can be an artificial intelligence (AI) neural network model. The livestream chat can allow livestream users 410 to interact with the livestream host and other viewers of the livestream in real time using text or voice. In embodiments, the chat text can appear in a window included in the livestream video. In some embodiments, voice interactions can be displayed as text in the chat window as they occur. In some embodiments, the chat can include video from the livestream users. A large language model (LLM) 430 can monitor the text chat window and voice chat messages and can respond using the same chat methods. The human assistant 440 can be a visible host of the livestream or can work off-camera as the livestream is rendered to viewers. The human assistant 440 can participate in the livestream chat using voice or text. Accessing the livestream can be accomplished using a browser or another application running on the device. The catalog of products can include information regarding multiple products. The information can include images, product specifications, pricing, availability, links to ecommerce sites associated with products, and/or other suitable information.

The infographic 400 can include monitoring, by a large language model (LLM) 430, the livestream chat, wherein the monitoring detects a question 420 from a user 410 within the plurality of users. In embodiments, the monitoring can include voice or video input from the user. The LLM monitoring can include audio and text viewer interactions between viewers, the livestream host, and the human livestream assistant. The viewer interactions can include questions 420, responses, and comments that occur during the livestream event. The monitoring by the LLM can include natural language processing (NLP). In embodiments, the livestream monitoring includes NLP to understand the text and the context of voice and text communication during the livestream. NLP can be used to detect one or more topics discussed by the livestream host and viewers. The LLM natural language processing can be used to detect questions 420 asked by livestream users 410.

The infographic 400 can include determining, by the LLM 430, an answer 432 to the question that was detected. In embodiments, the determining can include a plurality of potential answers to the question that was detected. The LLM 430 can search for one or more answers to the question that was detected from its database and render the answers in human-like language. The LLM can generate answers based on information from the vendor website, from the product catalog, from comments made by other users of the product, from product experts, from social media influencers, from salespeople, and so on. The LLM 430 can calculate an engagement metric 434 for the answer 432, wherein the engagement metric is predictive of a future engagement in the livestream, by one or more users within the plurality of users if the answer was posted in the livestream chat. The engagement metric 434 can use sales goals, the number of products viewed, and the number of products purchased. The engagement metric can also include views of short-form videos, multiple views of the same short-form video, sections of the livestream rewatched, number of likes, length of engagement, and so on. The engagement metrics can use website and viewer metadata. The metadata can include hashtags, purchase history, repost velocity, view attributes, view history, ranking, actions by one or more viewers, predicted user personality, predicted livestream sentiment impact, and so on. The engagement metric 434 can also be recorded to the metadata of products in the product catalog for future reference and refined as multiple users view the same livestream segment at different times. The engagement metric 434 can use stochastic analysis techniques to determine a score indicating the user level of interest and interaction with the livestream as it progresses. In embodiments, the LLM can calculate an engagement metric for each of the plurality of potential answers to the user questions that are detected. All answers generated by the LLM can be sorted by their predicted engagement score so that the best scoring answers appear first. Each answer 432 and its associated engagement metric 434 can be presented to the human assistant 440. In some embodiments, a threshold value can be established so that answers with engagement scores that fall below the threshold can be removed from the list and replaced by others. The LLM can highlight, to the human assistant, the answer with the highest engagement metric, and the answer with the engagement metric closest to the threshold value. Embodiments include recommending, by the LLM, an action 436 to the human assistant 440. In embodiments, the recommended action includes an LLM posting privately to a user or using a shadow post in response to a user's question or comment. The LLM or the human assistant may determine that a particular user tends to distract other viewers by asking one question after another or asking unrelated questions. Metadata, interactions from previous livestreams, data from other vendors or social media sites, etc., can be used to indicate user tendencies and patterns that lower engagement metric scores. For example, a user may ask questions or make comments that are intended to criticize or dissuade viewers from purchasing particular products or services from certain vendors. Thus, the LLM can recommend that such a user's question be ignored. In embodiments, the LLM recommends publishing a link to purchase an item that the user inquired about. In other embodiments, the LLM recommends that a second user answer the question posed by a first user to generate additional engagement. The second user can be selected based on past comment history, purchase history, metadata, and so on.

The infographic 400 can include publishing 470, in the livestream chat, an approved answer 460 to the question 420, wherein the engagement metric 434 is above a threshold value. Further embodiments include approving, by a human assistant 440, the answer to the question. In some embodiments, the human assistant can display all of the answers generated by the LLM to each user question, ranked by their associated engagement metric. The answers that fall below the established threshold value can be marked using color, an icon, italics, and so on. The publishing can further include editing 450, by the human assistant, the answer that was determined by the LLM. The human assistant can open a text box that includes a selected answer generated by the LLM and edit it. The human assistant can combine two or more answers to give a more complete perspective, reorder information within the answer, or change the wording to better fit the language of the user. Further embodiments include approving, by the human assistant, the answer that was edited 450 instead of the original answer generated by the LLM. The answer can include a weblink to purchase the one or more products.

The human assistant can choose to approve 460 and publish the answer 470 to all viewers of the livestream, or may publish it as a private communication to the user 410 asking the question. In some embodiments, the publishing can include a shadow post, wherein the shadow post restricts viewing of the answer to the user 410, and wherein the shadow post appears as a normal post to the user. The LLM 430 or the human assistant 440 may determine that a particular user tends to distract other viewers by asking one question after another or asking unrelated questions. Metadata, interactions from previous livestreams, data from other vendors or social media sites, etc., can be used to indicate user tendencies and patterns that lower engagement metric scores. For example, a user may ask questions or make comments that are intended to criticize or discourage viewers from purchasing particular products or services from certain vendors. There can be other reasons for the LLM or the human assistant to reply to a user using a shadow post so that the user receives an answer but does not distract the rest of the viewers or detract from the overall engagement of the livestream.

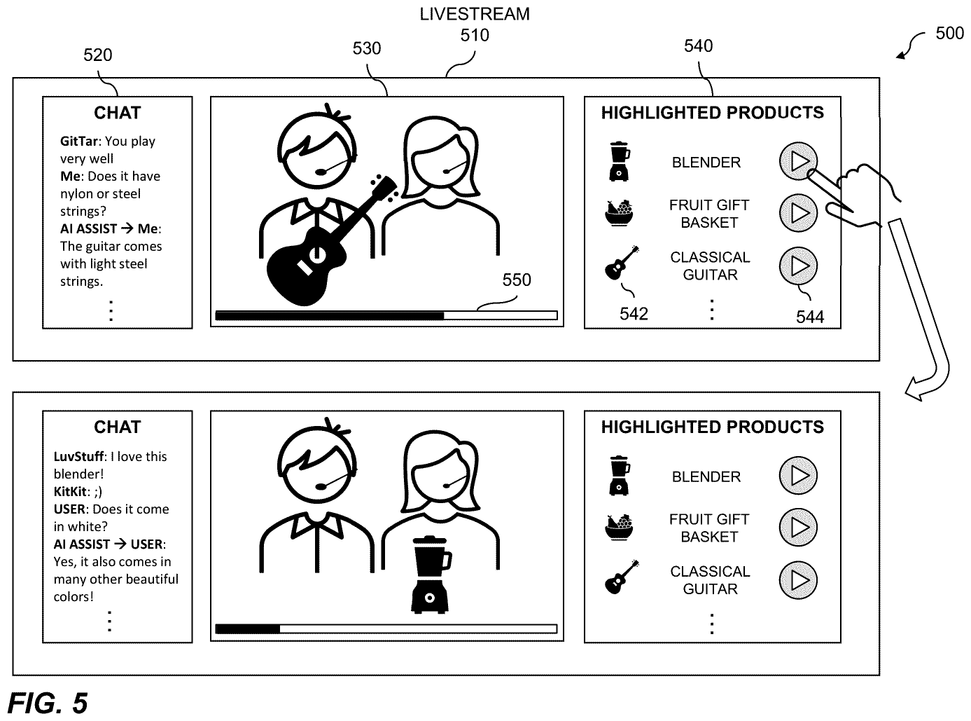

FIG. 5 is an infographic for rewinding a livestream 510. The infographic 500 can include adding one or more timestamps to the livestream 510, wherein each timestamp in the one or more timestamps represents a location in the livestream relevant to a product within the one or more products for sale. In embodiments, the adding can be accomplished dynamically by machine learning. In embodiments, timestamps are ingested by a time-series model to create LLM embeddings for associating speech context, host audio transcripts, and/or product highlights dynamically. As discussed above and throughout, a machine language large language model (LLM) can monitor a livestream chat 520 included in a livestream 510. The machine learning LLM can recognize words typed or spoken by the host 530 and users in the livestream. The words can include one or more products for sale in the livestream. The LLM can be used to identify words and phrases spoken, shouted, sung, etc. in the video and can translate them into text. The livestream can include a listing of the one or more products for sale. As the livestream progresses 510, products highlighted by the livestream host 530 can be identified by the LLM and matched to products for sale in the product catalog. In some embodiments, an image can be selected from the product catalog to represent each product. As the highlighted products are identified by the LLM and associated with product information in the product catalog, a list of the highlighted products 540 can be displayed to the livestream users. A timestamp marking the beginning and the end of each discussion highlighting a product can be recorded by the LLM and associated with the image 542 from the product catalog. In some embodiments, additional timestamps can be associated with the product image. The additional timestamps can be associated with a short-form video or 3D image of the product being highlighted; product specifications including color, dimensions, capacities, pricing; and so on. In embodiments, the list of products highlighted in the livestream can be rendered to the livestream viewers in a list displaying each highlighted product, a title for the product, and a button that allows the user to select the product. The timestamps can include selecting, by the user, a product within the one or more products for sale that were listed. The timestamps can further include rewinding the livestream to the timestamp relevant to the first product that was selected, wherein the timestamp relevant to the product that was selected occurs earlier than a current point in the livestream.

The infographic 500 shows a livestream 510 that includes a livestream chat 520, the livestream video including two hosts 530, and a list of highlighted products 540. A progress bar 550 is displayed near the bottom of the livestream video showing the user how much of the livestream video has been played. The list of highlighted products 540 includes a list of products highlighted by the livestream hosts. The list includes a picture of each product 542, a title for each product, and a button 544 that can allow the livestream user to advance or rewind the livestream video to a timestamp associated with the section of the livestream in which the host highlights the selected product. In the upper portion of FIG. 5, the livestream hosts 530 can be seen highlighting a guitar. The chat box 520 shows a discussion between two users, GitTar and Me, and the AI ASSIST LLM model. The user Me asks a question, “Does it have nylon or steel strings?” The AI ASSIST LLM responds “The guitar comes with light steel strings.” The progress bar 550 shows the user that the livestream is around two-thirds of the way through the entire livestream video. On the right side of the upper portion of FIG. 5, the user can be seen selecting the timestamp button 544 associated with a blender. The lower section of FIG. 5 shows the result of the selection of the button 544 for the blender. The progress bar below the livestream hosts shows that the livestream is now at an earlier point in the livestream video. The blender being highlighted by the hosts is on display in front of them. The livestream chat shows three users, LuvStuff, KitKit, and USER discussing the blender. USER asks a question, “Does it come in white?” The LLM detects the question, determines from the context of the discussion that the blender is being referred to by USER, finds an appropriate answer to the question, and posts the answer to the chat. The answer, “Yes, it also comes in many other beautiful colors!” has been determined to be the answer generated by the LLM with the highest engagement metric score, since it not only answers the question but encourages the livestream users to continue watching and post a follow-up question such as, “What other colors are available?”

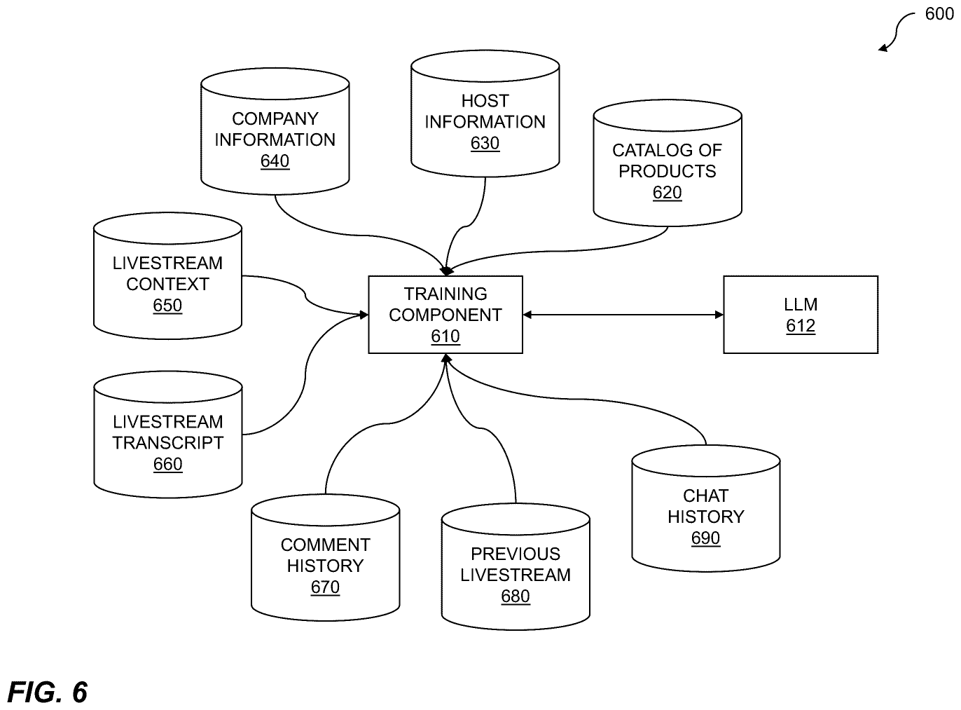

FIG. 6 is an example of training a large language model in a livestream. The example 600 can include a large language model (LLM) 612. A large language model is a type of machine learning model that can perform a variety of natural language (NLP) tasks, including generating and classifying text, answering questions in a human conversational manner, and translating text from one language to another. In embodiments, the LLM can access audio and text viewer interactions between viewers, the livestream host, and the human livestream assistant. The viewer interactions can include questions, responses, and comments that occur during the livestream event. The LLM can include natural language processing (NLP). NLP is a category of artificial intelligence (AI) concerned with interactions between humans and computers using natural human language. NLP can be used to develop algorithms and models that allow computers to understand, interpret, generate, and manipulate human language. NLP includes speech recognition; text and speech processing; encoding; text classification, including text qualities, emotions, humor, and sarcasm, and classifying it accordingly; language generation; and language interaction, including dialogue systems, voice assistants, and chatbots. In embodiments, the LLM includes NLP to understand the text and the context of voice and text communication during the livestream. NLP can be used to detect one or more topics discussed by the livestream host and viewers. Evaluating a context of the livestream can include determining a topic of discussion during the livestream; understanding references to and information from other livestreams; learning about products for sale or product brands; and becoming acquainted with livestream hosts associated with a brand, product for sale, or topic. The LLM natural language processing can be used to detect questions asked by livestream viewers.

The example 600 can include a training component 610 for the LLM 612. In embodiments, the training component 610 can include a catalog 620 of the one or more products for sale. The catalog can include product descriptions, dimensions, colors, patterns, pricing, shipping options, images, and so on. Metadata can be associated with each product, including number of sales, number of views, hashtags, purchase history, repost velocity, view attributes, view history, ranking, actions by one or more viewers, predicted user personality, predicted livestream sentiment impact, and so on. The training component can include host information 630 or company information 640. Host information can include information on brands offered, numbers of viewers, influencers, salespeople, store locations, and so on. Company information can include industry associations, asset size, stock information, advertising, and so on. The training can include a context of the livestream 650 or a transcript of the livestream 660. The training can include one or more previous livestreams 680. Livestreams can be associated with previous sales of the same or similar products, products offered in different regions, different hosts, social media influencer involvement, and so on. The training can include one or more previous comments 670 made by viewers, by livestream hosts, or by the LLM. The training can include a chat history 690 from the same or previous livestreams.

In embodiments, the training component 610 for the large language model 612 can use a genetic algorithm. A genetic algorithm is an adaptive heuristic search algorithm that can be used to generate high-quality sets of options for solving optimization questions, such as finding the best answers to a question generated by a user regarding a product for sale. In embodiments, a heuristic algorithm is used to generate solutions that are good enough to move forward in a reasonable time frame. They are essentially best guesses based on the available data that can be created quickly and used to create the next iteration of parameters for a generative AI model. The generative AI model can be trained with all the available information from the first iteration of short-form video generation, including the catalog of products for sale, information on the host website and the company selling the products in the product catalog, vendor information, previous livestreams related to particular products for sale, transcripts of previous livestreams, chat history, viewer comments, and so on. All of these inputs can be used to gather factual information about products, opinions expressed by users and vendors, alternate uses of products discovered by users or social media influencers, and so on. The language used by various sources can also be analyzed by the LLM, so that questions generated by users can be more easily understood, and the answers generated by the LLM can more closely match the language used by the viewers asking questions.

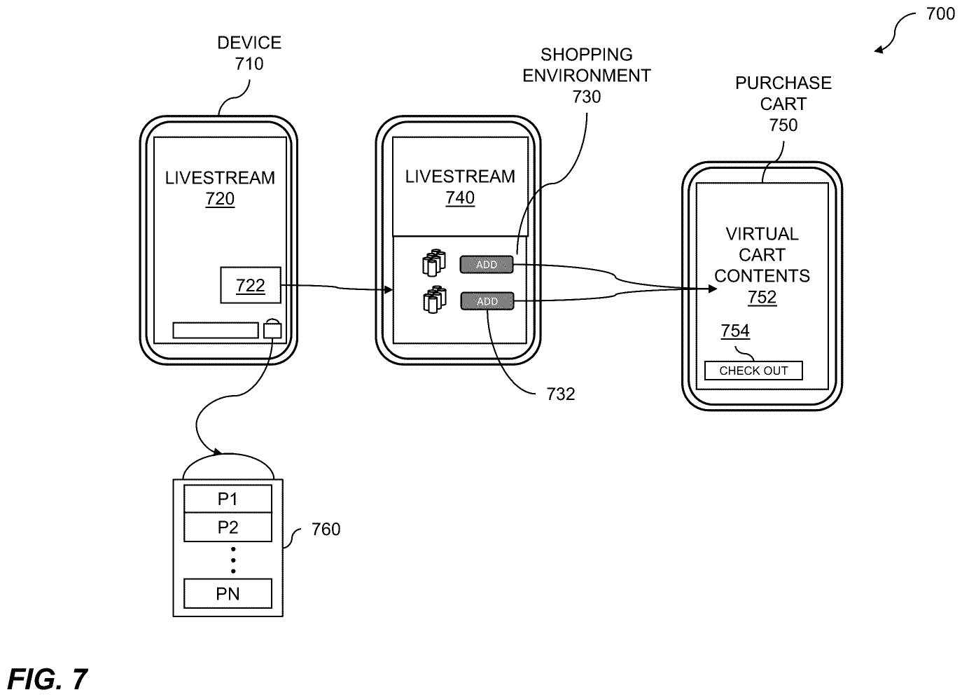

FIG. 7 is an example of an ecommerce purchase environment. As described above and throughout, a livestream can be accessed, hosted by one or more individuals, and viewed by one or more viewers. The livestream can highlight one or more products available for purchase. An ecommerce purchase can be enabled during a livestream using an in-frame shopping environment. The in-frame shopping environment can allow internet connected television (CTV) viewers and participants of the livestream to buy products and services during the livestream. The livestream can include an on-screen product card that can be viewed on a CTV device and a mobile device. The in-frame shopping environment or window can also include a virtual purchase cart that can be used by viewers as the livestream plays.

The example 700 can include a device 710 displaying a livestream 720. In embodiments, the livestream can be viewed in real time or replayed at a later time. The device 710 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the livestream on the device can be accomplished using a browser or another application running on the device.

The example 700 can include generating and revealing a product card 722 on the device 710. In embodiments, the product card represents at least one product available for purchase while the livestream plays. Embodiments can include inserting a representation of the first object into the on-screen product card. A product card is a graphical element such as an icon, thumbnail picture, thumbnail video, symbol, or other suitable element that is displayed in front of the livestream. The product card is selectable via a user interface action such as a press, swipe, gesture, mouse click, verbal utterance, or other suitable user action. The product card 722 can be inserted when the livestream is visible. When the product card is invoked, an in-frame shopping environment 730 is rendered over a portion of the livestream while the livestream continues to play. This rendering enables an ecommerce purchase 732 by a user while preserving a continuous livestream playback session. In other words, the user is not redirected to another site or portal that causes the livestream playback to stop. Thus, viewers are able to initiate and complete a purchase completely inside of the livestream playback user interface, without being directed away from the currently playing livestream. Allowing the livestream event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The example 700 can include rendering an in-frame shopping environment 730 and enabling a purchase of the at least one product for sale by the viewer, wherein the ecommerce purchase is accomplished within the livestream window 740. In embodiments, the livestream window can include the livestream or a prerecorded livestream video segment. The enabling can include revealing a virtual purchase cart 750 that supports checkout 754 of virtual cart contents 752, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. When multiple items 760 are purchased via product cards during the livestream, the purchases are cached until termination of the livestream, at which point the orders are processed as a batch. The termination of the livestream can include the user stopping playback, the user exiting the video window, the livestream ending, or a prerecorded livestream video ending. The batch order process can enable a more efficient use of computer resources, such as network bandwidth, by processing the orders together as a batch instead of processing each order individually.

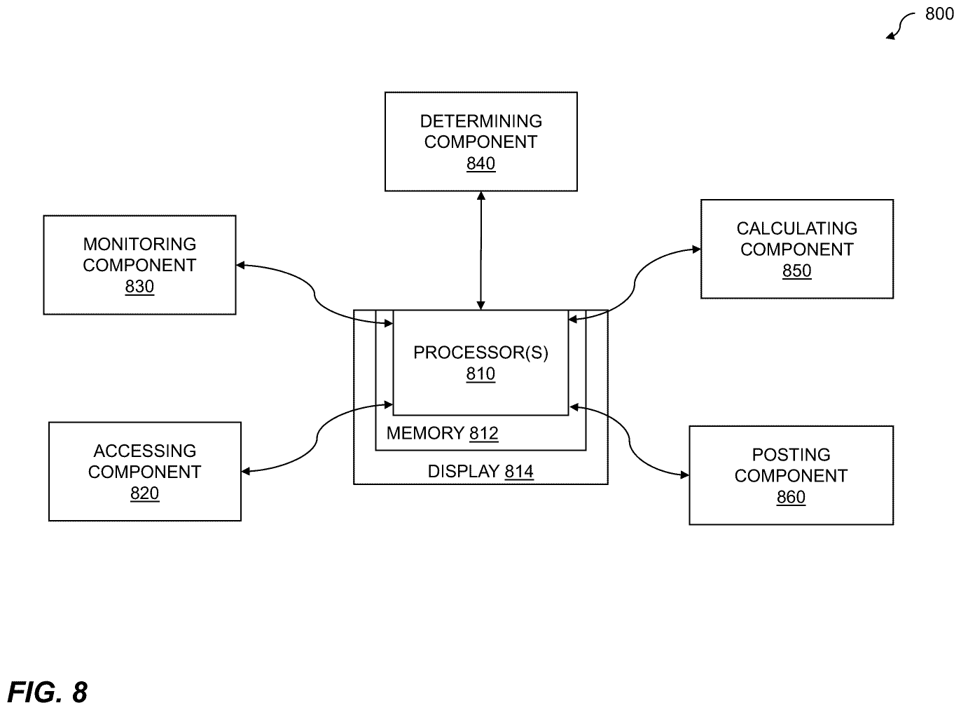

FIG. 8 is a system diagram for a livestream with large language model assist. The system 800 can include one or more processors 810 coupled to a memory 812 which stores instructions. The system 800 can include a display 814 coupled to the one or more processors 810 for displaying data, video streams, videos, intermediate steps, instructions, and so on. In embodiments, one or more processors 810 are coupled to the memory 812 where the one or more processors, when executing the instructions which are stored, are configured to: access a livestream, wherein the livestream includes a livestream chat and one or more products for sale from a catalog of products, and wherein the livestream includes at least one host and a plurality of users; monitor, by a large language model (LLM), the livestream chat, wherein the monitoring detects a question from a user within the plurality of users; determine, by the LLM, an answer to the question that was detected; calculate an engagement metric, for the answer, wherein the engagement metric is predictive of a future engagement in the livestream, by one or more users within the plurality of users, if the answer was posted in the livestream chat; and post, in the livestream chat, the answer to the question, if the engagement metric is above a threshold value.

The system 800 can include an accessing component 820. The accessing component 820 can include functions and instructions for accessing a livestream, wherein the livestream includes a livestream chat and one or more products for sale from a catalog of products, and wherein the livestream includes at least one host and a plurality of users. In embodiments, the livestream can comprise a livestream replay. The livestream can comprise a short-form video. In embodiments, the chat text can appear in a window included in the livestream video. In some embodiments, voice interactions can be displayed as text in the chat window as they occur. A large language model (LLM) can monitor the text chat window and voice chat messages and respond using the same chat methods. The livestream can be hosted by an ecommerce website, a social media network site, etc. The accessing includes all images, videos, audio, text, chats, media, and products for sale contained in the livestream. The livestream can include a human assistant. The human assistant can be a visible host of the livestream or can work off-camera as the livestream is rendered to viewers. The human assistant can participate in the livestream chat using voice or text. The catalog of products can include information regarding multiple products. The information can include images, product specifications, pricing, availability, links to ecommerce sites associated with products, and/or other suitable information.

The system 800 can include a monitoring component 830. The monitoring component 830 can include functions and instructions for monitoring, by a large language model (LLM), the livestream chat, wherein the monitoring detects a question from a user within the plurality of users. In embodiments, the monitoring can include voice input from the user. The LLM monitoring can include audio and text viewer interactions between viewers, the livestream host, and the human livestream assistant. The viewer interactions can include questions, responses, and comments that occur during the livestream event. The monitoring by the LLM can include natural language processing (NLP). In embodiments, the livestream audio monitoring can include NLP to understand the text and the context of voice and text communication during the livestream. NLP can be used to detect one or more topics discussed by the livestream host and viewers. Evaluating a context of the livestream can include determining a topic of discussion during the livestream; understanding references to and information from other livestreams; learning about products for sale or product brands; and becoming acquainted with livestream hosts associated with a brand, product for sale, or topic. The LLM natural language processing can be used to detect questions asked by livestream viewers.

The system 800 can include a determining component 840. The determining component 840 can include functions and instructions for determining, by the LLM, an answer to the question that was detected. In embodiments, the determining comprises a plurality of potential answers to the question that was detected. The LLM can search for one or more answers to the question that was detected from its database and render the answers in human-like language. The LLM can generate one or more answers. The LLM can generate answers based on information from the vendor website, from related websites, from comments made by other users of the product, from health care experts, from social media influencers, and so on.

The system 800 can include a calculating component 850. The calculating component 850 can include functions and instructions for calculating an engagement metric, for the answer, wherein the engagement metric is predictive of a future engagement in the livestream, by one or more users within the plurality of users, if the answer was posted in the livestream chat. In embodiments, the calculating can include the plurality of potential answers that were determined. The calculating can further comprise choosing, by the LLM, from the plurality of potential answers that were determined, the potential answer with a highest engagement metric. The engagement metric can use sales goals, the number of products viewed, the number of products purchased, views of short-form videos, multiple views of the same short-form video, sections of the livestream rewatched, number of likes, length of engagement, and so on. The engagement metrics can use website and viewer metadata. The metadata can include hashtags, purchase history, repost velocity, view attributes, view history, ranking, actions by one or more viewers, predicted user personality, predicted livestream sentiment impact, and so on. The engagement metric can be recorded to the metadata of highlighted products for sale for future reference, and can be refined as multiple users view the same livestream segment at different times. The engagement metric can use stochastic analysis techniques to determine a score indicating the user level of interest and interaction with the livestream as it progresses. In embodiments, the calculating can include the plurality of potential answers to the user questions that are detected. An engagement metric can also be calculated as a predicted score based on the various answers generated by the LLM. All answers generated by the LLM can be sorted by their predicted engagement score so that the best scoring answers appear first. In some embodiments, a threshold value can be established so that answers with engagement scores that fall below the threshold can be removed from the list and replaced by others.

The system 800 can include a posting component 860. The posting component 860 can include functions and instructions for posting, in the livestream chat, the answer to the question, wherein the engagement metric is above a threshold value. In embodiments, the posting can include highlighting, to the human assistant, the answer, wherein the engagement metric is close to the threshold value. The posting can include approving, by the human assistant, the answer to the question. The posting can include editing, by the human assistant, the answer that was determined by the LLM. The posting can further include publishing, by the human assistant, the answer that was edited. The posting can further include recommending, by the LLM, an action, to the human assistant. The posting can be accomplished in a private communication with the user. The posting can include a shadow post, wherein the shadow post restricts viewing of the answer to the user, and wherein the shadow post appears as a normal post to the user. The posting can include a weblink to purchase the one or more products.

The system 800 can include a computer program product is embodied in a non-transitory computer readable medium for video analysis, the computer program product comprising code which causes one or more processors to perform operations of: accessing a livestream, wherein the livestream includes a livestream chat and one or more products for sale from a catalog of products, and wherein the livestream includes at least one host and a plurality of users; monitoring, by a large language model (LLM), the livestream chat, wherein the monitoring detects a question from a user within the plurality of users; determining, by the LLM, an answer to the question that was detected; calculating an engagement metric, for the answer, wherein the engagement metric is predictive of a future engagement in the livestream, by one or more users within the plurality of users, if the answer was posted in the livestream chat; and posting, in the livestream chat, the answer to the question, if the engagement metric is above a threshold value.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video analysis comprising:
accessing a livestream, wherein the livestream includes a livestream chat and one or more products for sale from a catalog of products, and wherein the livestream includes at least one host and a plurality of users;
monitoring, by a large language model (LLM), the livestream chat, wherein the monitoring detects a question from a user within the plurality of users;
determining, by the LLM, an answer to the question that was detected;
calculating an engagement metric, for the answer, wherein the engagement metric is predictive of a future engagement in the livestream, by one or more users within the plurality of users, if the answer was posted in the livestream chat; and
posting, in the livestream chat, the answer to the question, if the engagement metric is above a threshold value.

2. The method of claim 1 wherein the determining comprises a plurality of potential answers to the question that was detected.

3. The method of claim 2 wherein the calculating includes the plurality of potential answers that were determined.

4. The method of claim 3 further comprising choosing, by the LLM, from the plurality of potential answers that were determined, the potential answer with a highest engagement metric.

5. The method of claim 1 wherein the livestream includes a human assistant.

6. The method of claim 5 further comprising approving, by the human assistant, the answer to the question.

7. The method of claim 5 further comprising editing, by the human assistant, the answer that was determined by the LLM.

8. The method of claim 7 further comprising publishing, by the human assistant, the answer that was edited.

9. The method of claim 5 further comprising highlighting, to the human assistant, the answer, wherein the engagement metric is close to the threshold value.

10. The method of claim 9 further comprising recommending, by the LLM, an action, to the human assistant.

11. The method of claim 1 further comprising adding one or more timestamps, to the livestream, wherein each timestamp in the one or more timestamps represents a location, in the livestream, relevant to a product within the one or more products for sale.

12. The method of claim 11 wherein the adding is accomplished dynamically by machine learning.

13. The method of claim 12 wherein the livestream includes a listing of the one or more products for sale.

14. The method of claim 13 further comprising selecting, by the user, a first product within the one or more products for sale that were listed.

15. The method of claim 14 further comprising rewinding the livestream to the timestamp relevant to the first product that was selected, wherein the timestamp relevant to the product that was selected occurs earlier than a current point in the livestream.

16. The method of claim 1 wherein the posting includes a shadow post, wherein the shadow post restricts viewing of the answer to the user, and wherein the shadow post appears as a normal post to the user.

17. The method of claim 1 further comprising training the LLM.

18. The method of claim 17 wherein the training includes the catalog of the one or more products for sale.

19. The method of claim 17 wherein the training includes a host information or a company information.

20. The method of claim 17 wherein the training includes a context of the livestream or a transcript of the livestream.

21. The method of claim 17 wherein the training includes one or more previous livestreams.

22. The method of claim 17 wherein the training includes one or more previous comments or a chat history.

23. The method of claim 1 wherein the monitoring includes voice input from the user.

24. The method of claim 1 wherein the posting is accomplished in a private communication with the user.

25. The method of claim 1 wherein the posting includes a weblink to purchase the one or more products.

26. A computer program product embodied in a non-transitory computer readable medium for video analysis, the computer program product comprising code which causes one or more processors to perform operations of:
accessing a livestream, wherein the livestream includes a livestream chat and one or more products for sale from a catalog of products, and wherein the livestream includes at least one host and a plurality of users;
monitoring, by a large language model (LLM), the livestream chat, wherein the monitoring detects a question from a user within the plurality of users;
determining, by the LLM, an answer to the question that was detected;
calculating an engagement metric, for the answer, wherein the engagement metric is predictive of a future engagement in the livestream, by one or more users within the plurality of users, if the answer was posted in the livestream chat; and
posting, in the livestream chat, the answer to the question, if the engagement metric is above a threshold value.

27. A computer system for video analysis comprising:
a memory which stores instructions;
one or more processors coupled to the memory wherein the one or more processors, when executing the instructions which are stored, are configured to:
access a livestream, wherein the livestream includes a livestream chat and one or more products for sale from a catalog of products, and wherein the livestream includes at least one host and a plurality of users;
monitor, by a large language model (LLM), the livestream chat, wherein the monitoring detects a question from a user within the plurality of users;
determine, by the LLM, an answer to the question that was detected;
calculate an engagement metric, for the answer, wherein the engagement metric is predictive of a future engagement in the livestream, by one or more users within the plurality of users, if the answer was posted in the livestream chat; and
post, in the livestream chat, the answer to the question, if the engagement metric is above a threshold value.
